(19) United States
(12) Patent Application Publication
(10) Pub. No.: US 2024/0320865 A1
(43) Pub. Date: Sep. 26, 2024

(54) DATA PROCESSING EQUIPMENT, DATA PROCESSING METHODS, AND PROGRAMS

(71) Applicant: NIPPON TELEGRAPH AND TELEPHONE CORPORATION, Tokyo (JP)

(72) Inventors: Yusuke SAKURAHARA, Musashino-shi, Tokyo (JP); Nazuki HONDA, Musashino-shi, Tokyo (JP); Masaaki INOUE, Musashino-shi, Tokyo (JP)

(73) Assignee: NIPPON TELEGRAPH AND TELEPHONE CORPORATION, Tokyo (JP)

(21) Appl. No.: 18/579,806

(22) PCT Filed: Aug. 6, 2021
(86) PCT No.: PCT/JP2021/029427

§ 371 Date: Jan. 16, 2024

(51) Int. Cl. G06T 9/00

(52) U.S. Cl. CPC G06T 9/001

(57) ABSTRACT

An object of the present invention is to provide a data processing device, a data processing method, and a program capable of compressing 3D point cloud data while maintaining the accuracy of restored coordinates to the extent that it can be used for a communication facility inspection technique. A data processing device according to the present invention divides measured point cloud data for each facility on the basis of a identification function, generates an image file in which each coordinate value is regarded as each color signal for each of the divided point cloud data, performs image compression processing on the image file with a compression ratio determined for each facility, and stores the image file subjected to the image compression processing and the parameters used for the image compression processing in association with each other.

### TECHNICAL FIELD

The present disclosure relates to a technique for compressing three-dimensional (3D) point cloud data as an image file or a moving image file.

### BACKGROUND ART

In recent years, facility inspection techniques using 3D laser scanners has been developed and efficient facility inspection has been realized. For inspection of communication facilities, there is a technique in which 3D point cloud data acquired using a mobile mapping system (MMS) or a fixed-type 3D laser scanner is used. This technique includes extracting a communication facility from the acquired 3D point cloud data, creating a 3D model, calculating facility information such as utility pole deflection, and visualizing the facility state. If it becomes possible to hold two sets of 3D point cloud data in a database and superimpose them on a screen, on-site inspections will become unnecessary and more efficient facility inspections and maintenance will be possible.

However, if 3D point cloud data acquired using a 3D laser scanner has x, y, and z coordinates, measurement is performed in a wide range, and measurement is performed under highly accurate conditions, an amount of data will become very large. For example, in the data size of a 3D point cloud, the data size measured in an MMS under the conditions of a speed of 30 km/h and a measurement distance of 1 km is about 15 GB and the data size measured in a fixed-type 3D laser scanner under the conditions of 500,000 points/second and a measurement angle of 15° (assuming the measurement of a single utility pole) is about 165 MB. Assuming that all of the utility poles in Japan are obtained, under the above measurement conditions, in an MMS, about 1.8 PB (converted assuming that the total length of roads in Japan is 1256607 km) is provided, and in a fixed point cloud, about 5.4 PB (converted assuming a total of 35 million utility poles) is provided. Thus, facility construction costs and running costs for storing all data are expensive.

For this reason, in order to hold the 3D point cloud data acquired all over Japan in a database at low cost, data compression is necessary. In order to significantly compress the 3D point cloud data, as in NPL 1, there is a method of pseudo-converting the x, y, and z coordinates of a 3D point cloud into color signals and compressing them using H.265/high efficiency video coding (HEVC) standardized by an international standardization organization.

### CITATION LIST

### Non Patent Literature

[NPL 1] Hierarchical H.265/HEVC Compression Encoding for Point Cloud Data Kazuya SATO, Kazuto KAMIKURA (Bulletin of Faculty of Engineering, Tokyo Polytechnic University Vol. 40 No. 1 (2017) P.47 to P.51)

### SUMMARY OF INVENTION

### Technical Problem

The volume of 3D point cloud data acquired using an MMS and fixed three-dimensional (3D) laser scanners is enormous and the facility construction costs and the running costs for holding and maintaining them become expensive. For this reason, data compression is required. In NPL 1, the coordinates of the 3D point cloud are pseudo-converted into YUV signals of color signals and the acquired point cloud data is collectively compressed using the image compression technique, which is irreversible compression.

However, the compression method of NPL 1 includes compressing the entire 3D point cloud data at once. Thus, the compression ratio cannot be adjusted for each facility. In addition, if the compression ratio is increased, the coordinate positions of all 3D point clouds change. If the coordinates of the 3D point cloud change significantly due to compression, the facility information calculated by creating the 3D model will differ, making it difficult to use it for a communication facility inspection technique.

Therefore, in order to solve the above problems, an object of the present invention is to provide a data processing device, a data processing method, and a program capable of compressing 3D point cloud data while maintaining the accuracy of restored coordinates to the extent that it can be used for a communication facility inspection technique.

### Solution to Problem

In order to achieve the above object, a data processing device according to the present invention divides measured point cloud data for each facility on the basis of a identification function, generates an image file in which each coordinate value is regarded as one color signal for each of the separate pieces of point cloud data, performs image compression processing on the image file with a compression ratio determined for each facility, and stores the image file subjected to the image compression processing and the parameters used for the image compression processing in association with each other.

Specifically, a data processing device according to the present invention is a data processing device which processes three-dimensional point cloud data representing three-dimensional coordinates of points on a surface of an outdoor structure acquired using a three-dimensional laser scanner including:
an image conversion part configured to generate an image file in which three-dimensional coordinates of each of the points of the three-dimensional point cloud data are regarded as color signals for each of the outdoor structures;
an image compression part which performs image compression processing on each of the image files at a compression ratio determined for each type of the outdoor structure corresponding to the image file; and
a storage part which stores a compressed image file subjected to the image compression processing and parameters used in the image compression processing in association with each other.

Also, a data processing method according to the present invention is a data processing method for processing three-dimensional point cloud data representing three-dimensional coordinates of points on a surface of an outdoor structure acquired using a three-dimensional laser scanner including: generating an image file in which three-dimensional coordinates of each point of three-dimensional point cloud data are regarded as color signals for each of outdoor structures;
performing image compression processing on each of the image files at a compression ratio determined for each type of the outdoor structure corresponding to the image file; and storing the compressed image file subjected to the image compression processing and the parameters used for the image compression processing in association with each other.

This data processing device and method performs compression at the time of performing image compression processing at a compression ratio according to the type of outdoor structure. For this reason, it is possible to maintain the accuracy of the restored coordinates required for each type of outdoor structure. Therefore, the present invention can provide a data processing device and a data processing method capable of compressing 3D point cloud data while maintaining the accuracy of restored coordinates to the extent that it can be used for a communication facility inspection technique.

The data processing device according to the present invention further includes a restoration part which converts the compressed image file into three-dimensional coordinate points using the compressed image file and the parameters stored in the storage part to generate restored point cloud data for each of the outdoor structures.

The image conversion part of the data processing apparatus according to the present invention converts a numerical value of the color signal corresponding to the three-dimensional coordinates of one point into a binary number and creates a plurality of image files for each 8 bits from the upper binary number. It is possible to restore accurate coordinates by converting 3D point cloud data into a plurality of image files.

The image conversion part of the data processing device according to the present invention includes:
(1) calculating a divisor of the number of point clouds included in the three-dimensional point cloud data for each of the outdoor structures 12,
(2A), when the number of point clouds is 8 or more and is not a prime number, setting the number of point clouds to x,
(2B), when the number of point clouds is less than 8 or is a prime number, so that it has a divisor other than 1 and the number of point clouds,
(a) providing dummy data to the three-dimensional point cloud data for each of the outdoor structures and setting the sum of the number of points and the number of dummy data to x, or
(b) deleting some points from the three-dimensional point cloud data for each of the outdoor structure and setting the number obtained by subtracting the number of deleted points from the number of point clouds to x, and
(3) creating the image file of pixels which can be represented by the two divisors of x described above.

When the number of point clouds in the 3D point cloud data is a prime number, normal compression cannot be performed, so compression is possible by deleting points or adding dummy points.

The image compression part of the data processing device according to the present invention has the same type of outdoor structure and collectively performs moving image compression processing on a plurality of the image files generated from the outdoor structures existing at different locations to obtain the compressed image file (compressed moving image file). The 3D point cloud data of the same kind of outdoor structures are similar. For this reason, handling these pieces of data as moving images enables higher compression.

When the moving image is compressed, the restoration part extracts an arbitrary image file from the compressed image file which is a compressed moving image, converts it into points of three-dimensional coordinates, and generates restored point cloud data for each of the outdoor structures.

The present invention is a program for causing a computer to function as the data processing device. The data collection device of the present invention can also be realized using a computer and a program and the program can be recorded on a recording medium or provided over a network.

Note that the above inventions can be combined as far as possible.

### Advantageous Effects of Invention

The present invention can provide a data processing device, a data processing method, and a program capable of compressing 3D point cloud data while maintaining the accuracy of restored coordinates to the extent that it can be used for a communication facility inspection technique.

### BRIEF DESCRIPTION OF DRAWINGS

FIG. 1 is a diagram for explaining a data processing device according to the present invention.

FIG. 2 is a diagram for explaining identification work performed using an identification processing part of the data processing device according to the present invention.

FIG. 3 is a diagram for explaining image file creation work performed using an image conversion part, compression work performed using an image compression part, and point cloud restoration work performed using a restoration part of the data processing device according to the present invention.

FIG. 4 is a flowchart for explaining image file creation work performed using the image conversion part of the data processing device according to the present invention.

FIG. 5 is a flowchart for explaining compression work performed by an image compression part of the data processing device according to the present invention.

FIG. 6 is a flowchart for explaining compression work performed by the image compression part of the data processing device according to the present invention.

FIG. 7 is a flowchart for explaining point cloud restoration work performed by a restoration part of the data processing device according to the present invention.

FIG. 8 is a diagram for explaining the data processing device according to the present invention.

### DESCRIPTION OF EMBODIMENTS

Embodiments of the present invention will be described with reference to the accompanying drawings. Embodiments which will be described later are examples of the present invention and the present invention is not limited to the following embodiments. Note that, in this specification and the drawings, constituent elements having the same reference numerals are the same as each other.

### Embodiment 1

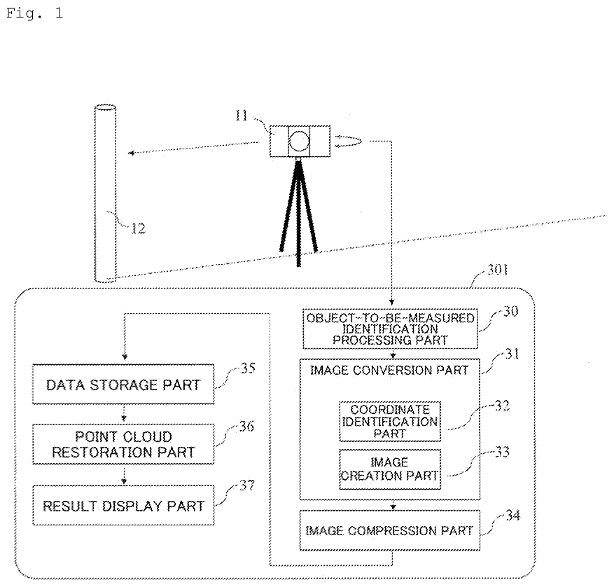

FIG. 1 is a diagram illustrating a data processing device 301 of this embodiment. The data processing device 301 is a data processing device which processes three-dimensional point cloud data representing the three-dimensional coordinates of points on surfaces of outdoor structures 12 acquired using a three-dimensional laser scanner 11, and includes an image conversion part 31 configured to generate an image file in which three-dimensional coordinates of each point of three-dimensional point cloud data are regarded as color signals for each of the outdoor structures 12, an image compression part 34 configured to perform image compression processing on each of the image files at a compression ratio determined for each type of the outdoor structures 12 corresponding to the image file, and A storage part 35 configured to store the compressed image file subjected to the image compression processing and the parameters used for the image compression processing in association with each other.

Also, the data processing device 301 further includes a restoration part 36 configured to generate restored point cloud data for each of the outdoor structures 12 by converting the compressed image file into points of three-dimensional coordinates using the compressed image file and the parameters stored in the storage part 35. Furthermore, the data processing device 301 includes an identification processing part 30 and a display part 37. The image conversion part 31 has a coordinate identification part 112 and an image creation part 113. Note that the outdoor structure 12 is a communication facility to be inspected such as a utility pole, a cable, and a transformer.

The identification processing part 30 separates the 3D point cloud data measured using the 3D laser scanner 11 into point clouds for each type of the outdoor structure 12. The image creation part 33 of the image conversion part 31 converts the 3D point cloud data separated by a type of the outdoor structure 12 into an image file. The coordinate identification part 32 calculates coordinate information necessary for pseudo-converting coordinates into color signals. The image compression part 34 compresses the image file at a compression ratio determined for each type of outdoor structure 12. The storage part 35 stores compressed image files and parameters used for image compression. The restoration part 36 inversely transforms the color signals into coordinates from the image file and the parameters stored in the storage part 35. The display part 37 displays 3D point cloud data inversely transformed from color signals to coordinates.

### [Identification Processing Part]

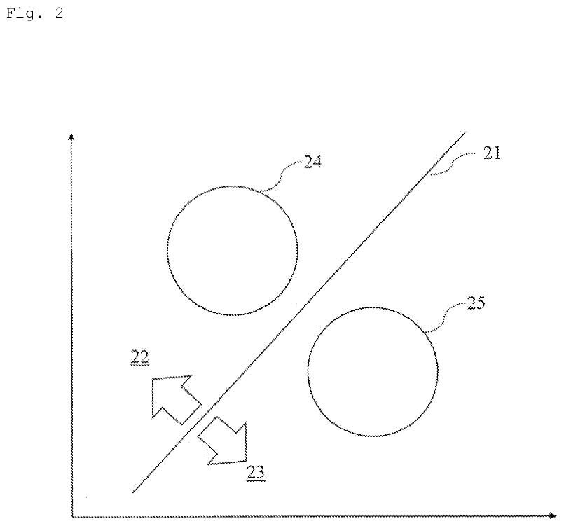

FIG. 2 is a diagram for explaining a method of identifying an arbitrary object from a point cloud performed by the identification processing part 30. The identification surface 21 of this embodiment refers to a linear boundary surface used for object identification and is a boundary plane between Class 1 and Class 2. Here, if a specific example is described, Class 1 is a utility pole and Class 2 is a scaffolding bolt. It is possible to classify the points into two groups, namely, a point cloud forming a utility pole and a point cloud forming a scaffolding bolt by deriving the identification surface 21 by machine learning based on the learning data. The coordinates S of the 3D point cloud data with the total number of points N will be provided as below.

$$\\ \begin{matrix}[ Math . 2.1 ] & \\ S = ( \begin{matrix}x = {x}_{1} & {x}_{2} … {x}_{N} \\ y = {y}_{1} & {y}_{2} … {y}_{N} \\ z = {z}_{1} & {z}_{2} … {z}_{N}\end{matrix} ) & ( 2.1 )\end{matrix}$$

A method of obtaining an identification function f (x) for an acquired point cloud and deriving the identification surface 21 using a perceptron as an example will be described. A discrimination function f (a) when input data is A=(a₁, a₂, a₃, . . . , a_{N}) is expressed by the following expression.

$$\\ \begin{matrix}[ Math . 2.2 ] & \\ f ( a ) = {w}_{0} + {a}_{1} {w}_{1} + {a}_{2} {w}_{2} + {a}_{3} {w}_{3} + … + {a}_{N} {w}_{N} & \end{matrix}$$

Here, W=(w₀, w₁, w₂, w₃, . . . , w_{N}) indicates the weight for each feature amount.

Class 1 is set to be an area larger than f (a) (f(a)>0), Class 2 is set to be an area smaller than f (a) (f (a)<0), a point cloud of Class 1 is set to be Sc, and a point cloud of Class 2 is set to be S_{c2}. The identification function f (a) is calculated as input data A=(xₙ, yₙ, zₙ) and a determination concerning whether the points included in each class 1 and 2 can be correctly identified is checked. When it can be identified normally is assumed to be f (a)>0 at the time of inputting a point of Class 1 and f (a)<0 at the time of inputting a point of Class 2.

The weights of the identification function are corrected until all the data are correctly discriminated using two expressions, such as, when Class 1 is misidentified as a result of the calculation, that is, when f (a)<0 at the time of inputting a point of Class 1:

$$\\ \begin{matrix}[ Math . 2.3 ] & \\ {w}^{{}_{} ′} = w + η A . & \end{matrix}$$

When Class 2 is misrecognized, that is, when f (a)>0 at the time of inputting Class 2 points:

$$\\ \begin{matrix}[ Math . 2.4 ] & \\ {w}^{{}_{} ′} = w - η A . & \end{matrix}$$

η indicates a learning rate. Finally, a identification function f′ (a) with modified weights and a identification surface f′ (a)=0 can be derived. With this method, an object can be identified from a point cloud on the basis of learning data.

FIG. 2 is an example with two identification objects and it is possible to increase the number of identifiable classes and increase the number of identifiable objects by increasing the number of linear identification surfaces. For example, when increasing the discriminant surface by one and making three classifiable classes, it is possible to classify the point cloud into three types of facility by assigning Class 1 to utility poles, Class 2 to scaffolding bolts, and Class 3 to cables. As described above, it becomes possible to classify acquired point clouds into point clouds for each facility to be identified by preparing a plurality of identification surfaces.

### [Image Conversion Part, Image Compression Part, Restoration Part]

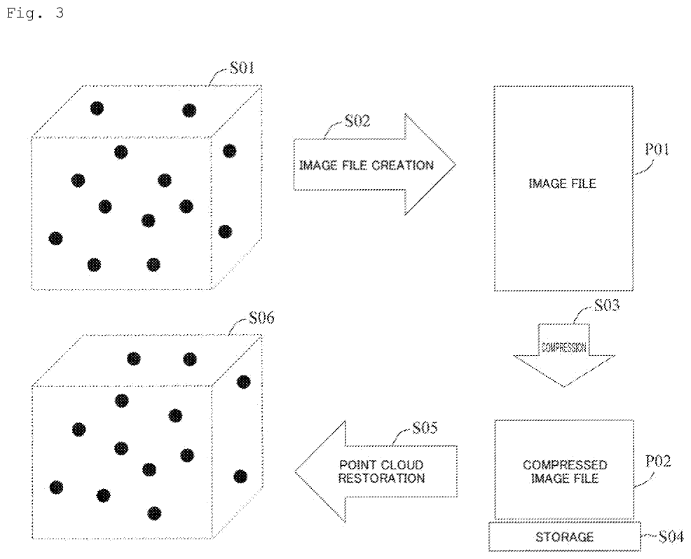

FIG. 3 is a diagram for explaining image file creation work performed by the image conversion part 31, compression work performed by the image compression part 34, and point cloud restoration work performed by the restoration part 36.

The 3D point cloud data acquired by the 3D laser scanner 11 has coordinates (x, y, z) (Step S01). On the other hand, image files also have color signals (R, G, B) or (Y, U, V). Since both coordinates and color signals have three variables, they can be mutually converted. The image conversion part 31 pseudo-converts the coordinates (x, y, z) into RGB signals or YUV signals (YCbCr signals) and creates an image file P01 in an arbitrary format (PNG, TIFF, or the like) (Step S02). Each image compression technique determines whether it accepts an RGB signal or a YUV signal as an input signal. For this reason, the image conversion part 31 determines which signal is used to create the image file on the basis of the image compression technique of the image compression part 34. Note that the image compression technique of the image compression part 34 includes not only a still image compression technique but also a moving image compression technique, which will be described later.

The image compression part 34 compresses the image file P01 using an arbitrary compression technique to generate a compressed image file P02 (Step S03). Note that the compressed image file P02 includes not only files obtained by compressing still images, but also files obtained by compressing moving images, which will be described later. The storage part 35 saves the 3D point cloud data by storing the compressed image file P02 and the parameters at the time of compression (Step S04). The restoration from the image file to the 3D point cloud data is performed in reverse order of the procedure of compression. Specifically, when it is desired to display the 3D point cloud on the display part 37, the restoration part 36 retrieves the compressed image file P02 and parameters from the storage part 35, returns them to the image file P01 using the arbitrary compression technique, and restores the coordinates (x, y, z) from the image file P01 (Steps S05 and S06).

### [Image Conversion Part]

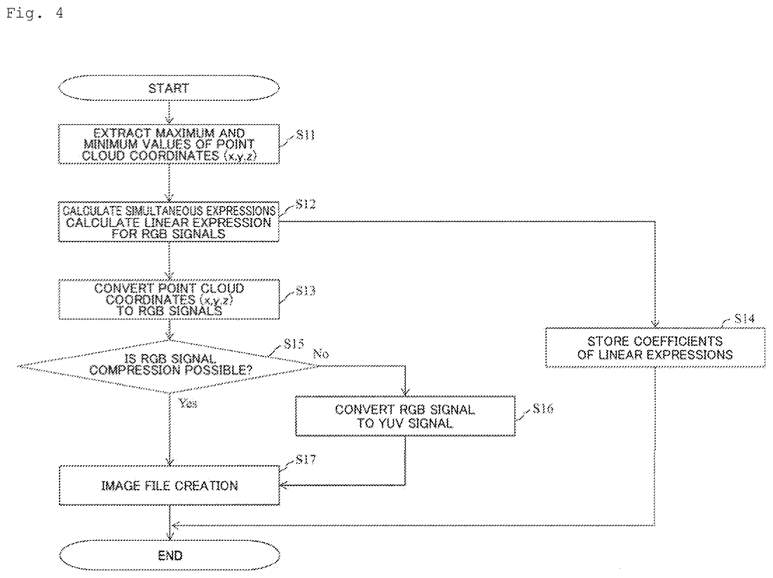

FIG. 4 is a flowchart for explaining an operation of the image conversion part 31 configured to convert point cloud coordinates (x, y, z) into color signals and creating an image file from the calculated color signals. The image conversion part 31 has a coordinate identification part 32 and an image creation part 33, the coordinate identification part 32 performs Steps S11 to S14, and the image creation part 33 performs Steps S15 to S17.

Here, an example of converting point cloud coordinates Sc included in Class 1 described with reference to FIG. 3 into color signal C will be described. An expression for converting the point cloud coordinates S_{c1} into the color signal C is expressed as follows.

$$\\ \begin{matrix}[ Math . 4.1 ] & \\ 0 = P \cdot {S}_{c 1 min} + Q & \end{matrix}$$

$$\\ \begin{matrix}[ Math . 4.2 ] & \\ {2}^{{}_{} 8} - 1 = P \cdot {S}_{c 1 max} + Q & \end{matrix}$$

Here, P and Q are linear function constants for converting coordinate values into color signals, P is a slope of the linear function, and Q is an intercept of the linear function.

Any coordinate S_{c1n} can be converted into a color signal C by the following equation using P and Q derived by solving these simultaneous expressions. P and Q are the aforementioned parameters.

$$\\ \begin{matrix}[ Math . 4.3 ] & \\ C = P \cdot {S}_{c 1 n} + Q & \end{matrix}$$

Here, S_{c1max} indicates a maximum value of each of point cloud coordinates (x, y, x) included in the 3D point cloud data, Sc1min indicates a minimum value of each point cloud coordinate (x, y, x) included in the 3D point cloud data, and the color signal C=(R, G, B).

For example, if S_{c1max} is x_{c1max}, S_{c1min} is x_{c1min}, S_{c1n} is x_{c1n}, and C is R, the x coordinate can be converted into a color signal R. The y-coordinate and the z-coordinate can be converted into color signals G and B by performing similar calculations.

That is to say, first, the coordinate identification part 32 extracts the maximum and minimum values of the point cloud coordinates (x, y, z) from the 3D point cloud data separated for each piece of facility by the identification processing part 30 (Step S11). Subsequently, the coordinate identification part 32 substitutes the maximum value and minimum value of each coordinate into the expression (4.1) and (4.2) and calculates the slope P and the intercept Q of the linear expression of the expression (4.3) (Step S12). Note that, since the slope P and the intercept Q are necessary at the time of restoring the point cloud, they are stored in the storage part 35 (Step S14). Also, the coordinate identification part 32 converts the coordinates (x, y, z) of each point included in the point cloud into RGB signals using the expression (4.3) (Step S13).

When the image compression technique used by the image compression part 34 receives an input of RGB signals (“Yes” in Step S15), the image creation part 33 creates an image file in an arbitrary format using the RGB signals obtained by converting the point cloud coordinates (Step S17). On the other hand, when the image compression technique used by the image compression part 34 receives an input of the YUV signal (“No” in Step S15), the image creation part 33 converts the RGB signal obtained by converting the point cloud coordinates into a YUV signal (Step S16). There are several expressions for conversion from RGB signals to YUV signals and one example is shown below.

$$\\ \begin{matrix}[ Math . 4.4 ] & \\ ( \begin{matrix}Y \\ U \\ V\end{matrix} ) = ( \begin{matrix}0.2126 & 0.7152 & 0.0722 \\ - 0.114572 & - 0.385423 & 0.5 \\ 0.5 & - 0.454153 & - 0.045847\end{matrix} ) ( \begin{matrix}R \\ G \\ B\end{matrix} ) + ( \begin{matrix}0 \\ 128 \\ 128\end{matrix} ) & ( 4.4 )\end{matrix}$$

The image creation part 33 creates an image file using the values converted into YUV signals by this expression (Step S17). In this way, the image creation part 33 creates an image file in a format corresponding to the image compression technique of the image compression part 34.

In the above example, in the expression (4.2), the solution of the expression for Sₘₐₓ is 2⁸-1 so that the maximum number after conversion is 2⁸−1=255. This is because the color signal RGB is represented by 8 bits (0 to 255). That is to say, since the number of convertible values of point cloud coordinates which have a wide range of numbers from the minimum value to the maximum value is 256 such as 0 to 255, the coordinates which can be expressed during restoration are limited.

Thus, it is preferable that the image conversion part 31 convert the numerical value of the color signal corresponding to the three-dimensional coordinates of one point into a binary number and create a plurality of image files for each 8 bits from the upper binary number. A specific description will be provided below.

In order to restore the point cloud coordinates more accurately, the convertible values of the point cloud coordinates are set to 2⁸ to 2¹⁶, 2²⁴, . . . , 2⁸ⁱ (i is an integer of 2 or more). When the number of convertible values of point cloud coordinates is set to be larger than 2⁸, the color signal RGB is represented by 8 bits. Thus, it is necessary to divide the converted numbers into 8-bit units. For example, when the number of convertible values of the point cloud coordinates is set to be 2¹⁶-1, after converting the converted decimal value to a binary number, the upper 8 bits and the lower 8 bits are divided, each 8-bit value is treated as the color signal RGB, and an image file composed of the upper 8 bits and a file composed of the lower 8 bits are created and stored.

That is to say, if the original RGB signal is (R¹⁶ bits, G¹⁶ bits, B¹⁶ bits), the original RGB signal is divided into (R^{upper 8 bits}, G^{upper 8 bits}, B^{upper 8 bits}) and (R^{lower 8 bits}, G^{lower 8 bits}, B^{lower 8 bits}) and they each create image files. Thus, since the number of convertible values of point cloud coordinates is 65536 (=2¹⁶) such as 0 to 65535, coordinates can be restored more accurately than the formula using 2⁸ at the time of restoration.

From this, when the number of convertible values of the point cloud coordinates is 2⁸ⁱ (i=1, 2, 3, . . . ), it is possible to set 2⁸ⁱ that is the number of convertible values of point cloud coordinates by dividing it into i pieces with 8 bits and creating an image file for each after converting the decimal value to the binary number. Here, if the number of convertible values of point cloud coordinates is 2⁸ⁱ, the number of image files which need to be created increases to i and the compression ratio of 3D point cloud data deteriorates.

Thus, since some types of outdoor structures do not require high restoration accuracy, i in 2⁸ⁱ that is the number of convertible values of point cloud coordinates can be freely selected for each facility.

The image conversion part 34 is characterized
in that (1) a divisor of the number of point clouds included in the three-dimensional point cloud data for each of the outdoor structures 12 is calculated,
in that (2A), when the number of point clouds is 8 or more and is not a prime number, the number of point clouds is set to be X,
(2B), when the number of point clouds is less than 8 or is a prime number, so that it has a divisor other than 1 and the number of the point clouds,
(a) dummy data is provided to the three-dimensional point cloud data for each of the outdoor structures 12 and the sum of the number of points and the number of dummy data is set to be x, or
(b) some points are deleted from the three-dimensional point cloud data for each of the outdoor structure 12s and the number obtained by subtracting the number of the deleted points from the number of the point cloud is set to be x, and in that (3) the image file of pixels which can be represented by the two divisors of x described above is created.

The image creation part 34 creates an image file so that x=a×b pixels are acquired for the acquired point cloud number x. Although a and b are divisors of x and need to be 8 or more from the technique of image compression technique, in fact, there are cases in which the divisors of x are only 1 and x (where x is a prime number). A 1×x pixel image file will not compress properly when compressed. For this reason, the image creation part 34 adjusts x to be 8 or more and to have a divisor other than 1 and x by deleting the point cloud when the outdoor structure 12 does not require high-precision reconstruction accuracy, on the other hand, by providing a dummy point cloud to the 3D point cloud data when the outdoor structure 12 requires high-precision reconstruction accuracy.

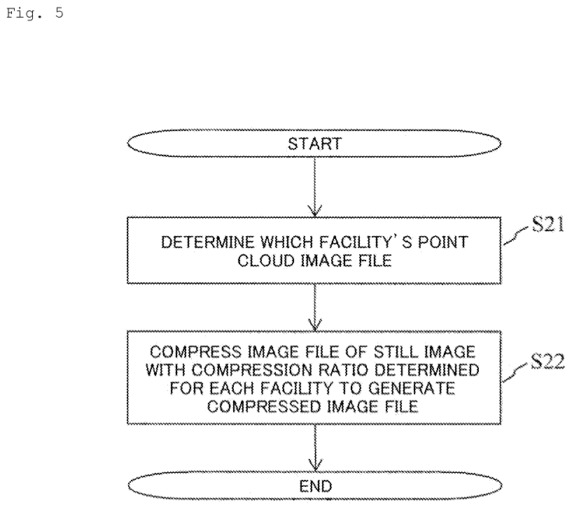

FIG. 5 is a flowchart for explaining the image file compression work of a still image performed by the image compression part 34. The image compression part 34 determines which outdoor structure 12 the point cloud image file belongs to (Step S21). For example, the image compression part 34 uses the determination result of the identification processing part 30 to determine the type of the outdoor structure 12 for each image file. Also, the image compression part 34 compresses the image file at a compression ratio predetermined for each type of outdoor structure 12 to generate a compressed image file (Step S22). In this way, the image compression part 34 can determine the identified outdoor structure and adjust the restoration accuracy by changing the compression ratio for each type of outdoor structure.

Specifically, when the outdoor structure 12 does not require high restoration accuracy, setting a high image compression ratio reduces the restoration accuracy but reduces the data volume. On the other hand, when the outdoor structure 12 requires high restoration accuracy, setting the image compression ratio low reduces the effect of reducing the data volume, but makes it possible to maintain the restoration accuracy. The outdoor structure 12 to be inspected is set to have an image file compression ratio in which facility state values (measured values or the like) in inspections using pre-compressed point clouds do not differ from facility state values (measured values or the like) in inspections using point clouds with restored image compression.

The image compression part 34 can use general image compression techniques in addition to the use of internationally standardized techniques such as jpeg and png as image compression techniques. As an example, the compression theory of jpeg will be described. First, the RGB signal of the input image file is converted to a YUV signal. Compression is performed by thinning out the color difference components of the YUV signal. Typical YUV ratios are 4:4:4, 4:2:2, 4:1:1, and 4:2:0, with 4:4:4 being the highest quality image. After thinning out the color difference components, discrete cosine transform (DCT transform) is independently performed on each of the YUV signals. When the discrete cosine transform is performed on the image signal f (a,b) obtained by dividing the YUV signal into A×B pixels, the following equation is obtained.

$$\\ \begin{matrix}[ Math . 5.1 ] & \\ F ( v , w ) = \sqrt{\frac{2}{A}} \sqrt{\frac{2}{B}} {C}_{v} {C}_{w} {\sum }_{a = 0}^{A - 1} {\sum }_{b = 0}^{B - 1} f ( a , b ) cos \frac{( 2 a + 1 ) v π}{2 A} cos \frac{( 2 b + 1 ) w π}{2 B} & ( 5.1 )\end{matrix}$$

$$\\ {C}_{v} = \{ \begin{matrix}1 ( v = 1 , 2 , … , A - 1 ) \\ \frac{1}{\sqrt{2}} ( v = 0 )\end{matrix} {C}_{w} = \{ \begin{matrix}1 ( w = 1 , 2 , … , B - 1 ) \\ \frac{1}{\sqrt{2}} ( w = 0 )\end{matrix}$$

Quantized data F_{q}(v, w) can be calculated by dividing F (v, w) calculated by the DCT transform by the quantization table Q(v, w).

$$\\ \begin{matrix}[ Math . 5.2 ] & \\ {F}_{q} ( v , w ) = round \{ \frac{F ( v , w )}{α Q ( v , w )} \} & ( 5.2 )\end{matrix}$$

By adjusting the value of α, the quantized data can be adjusted and the compression ratio can be set to any ratio. After that, it is entropy coded, multiplexed by bit string processing, and then output in a jpeg format.

In the above flow, by setting an appropriate compression ratio, it is possible to compress 3D point cloud data without causing problems in the inspection of the outdoor structure 12 using the point cloud. For example, when the compression ratio α can be selected from 10 levels (the smaller the number, the higher the quality and the lower the compression), the point cloud image files required for model creation can increase the compression ratio of the 3D point cloud data as a whole while maintaining the calculation accuracy of the facility state through facility inspection technique using point clouds by setting the compression ratio α to 1 and setting the compression ratio α to 10 for point cloud image files which are not necessary for model creation.

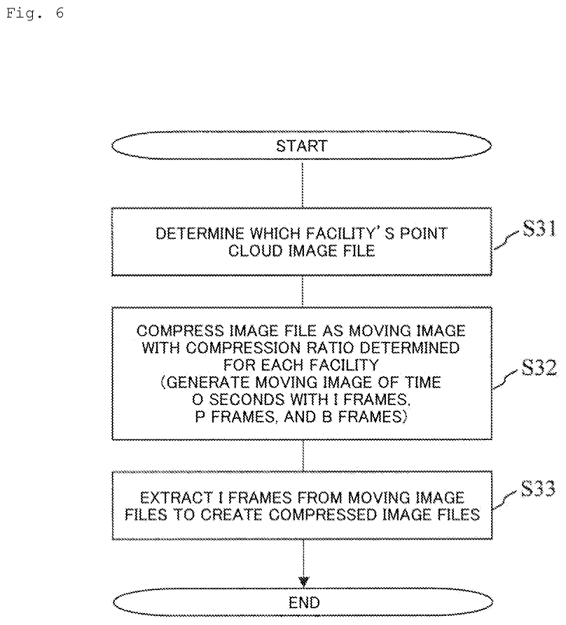

FIG. 6 is a flowchart for explaining an operation of compressing an image file using the image compression part 34 using an image compression technique for compressing a moving image (hereinafter sometimes referred to as “moving image compression technique”). The image compression part 34 determines which outdoor structure 12 the point cloud image file belongs to (Step S31). For example, the image compression part 34 uses the determination result of the identification processing part 30 to determine the type of the outdoor structure 12 for each image file. Also, the image compression part 34 compresses the image file at a compression ratio predetermined for each type of outdoor structure 12 (Step S32). Here, since the image compression part 34 uses a moving image compression technique, a moving image of 0 seconds having I frames, P frames, and B frames (for each outdoor structure 12) is generated from one image file. The image compression part 34 extracts the I frame from the moving image and converts it into a compressed image file (Step S33). In this way, even if the moving image compression technique is used, the image compression part 34 can determine the identified outdoor structure in the same manner as the image compression technique described with reference to FIG. 5 and adjust the restoration accuracy by changing the compression ratio for each type of outdoor structure.

Considering the restoration accuracy and data volume required by the outdoor structure 12, the moving compression ratio in which facility state values (measured values or the like) in inspections using pre-compressed point clouds do not differ from facility state values (measured values or the like) in inspections using point clouds with restored image compression is provided.

The image compression part 34 can use general moving image compression techniques in addition to internationally standardized techniques such as MPEG-4 as moving image compression techniques. Although a moving image compression technique has functions such as DCT conversion and quantization like the image compression technique, unique functions thereof are motion detection and inter-frame prediction. These are techniques for specifying a moving portion in a series of images and compressing information other than the moving portion. With inter-frame prediction, compressing a single image file creates a 0-second video file with I-frames, P-frames, and B-frames. It is possible to extract a compressed image file which has been compressed using a moving image compression technique by extracting the I-frame from it. It becomes possible to store the compressed 3D point cloud data by saving the compressed image file.

As in the description of the image compression technique in FIG. 5, it is possible to compress 3D point cloud data without causing problems in inspection of the outdoor structure 12 using the point cloud by setting an appropriate compression ratio α.

In the description of the compression of 3D point cloud data using the moving image compression technique described above, an example of extracting and storing a target image (I frame) from a moving image created from one image file is described. Due to the characteristics of the moving image compression technique, when the consecutive image files are similar, the compression effect can be expected to be greater. Since the arrangement of coordinates of 3D point cloud data is similar for each facility, similar images are created when image files are created for each facility. For this reason, it is possible to store a highly compressed file by applying the moving image compression technique to the image file of each facility and storing the compressed moving image file.

Therefore, it is preferable that the image compression part 34 collectively perform moving image compression processing on a plurality of the image files generated from the outdoor structures 12 of the same type and located at different locations to obtain the compressed image files (compressed moving image file).

In this case, the restoration part 36 extracts an arbitrary image file from the compressed image file which is a compressed moving image, converts it into points of three-dimensional coordinates, and generates restored point cloud data for each of the outdoor structures.

For example, at the time of photographing using an MMS, the data processing device 301 divides the point clouds acquired in different scenes 1, 2, and 3 for each facility and puts together the three image files of the utility pole created using the moving image compression technique. This makes it possible to store three image files as one moving image file. In this case, the data processing device 301 needs to store in the storage part 35, as a parameter, information indicating in which frame in the moving image the image file whose point cloud coordinates are to be restored is stored and to extract the image file on the basis of the information when needed.

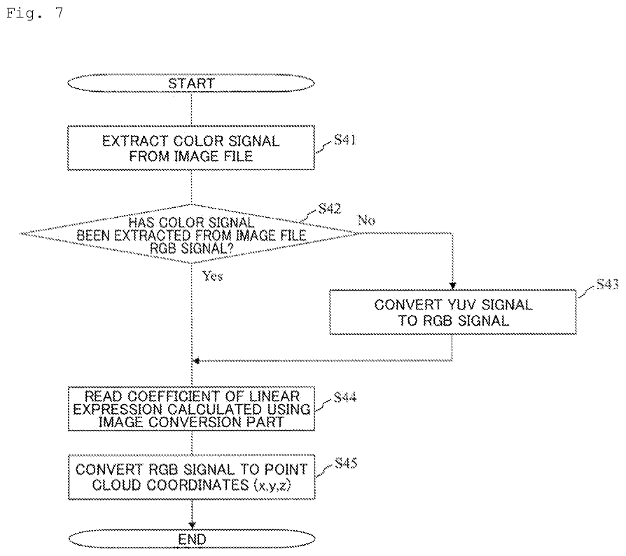

FIG. 7 is a flowchart for explaining an operation of restoring point cloud information from a compressed image file which is performed by the restoration part 36. The restoration part 36 restores the point cloud by performing inverse transformation in the reverse order of the flow in FIG. 4. First, the restoration part 36 extracts color signals from the compressed image file (Step S41). When the YUV signal is extracted (“No” in Step S42), the restoration part 36 performs inverse conversion from expression (4.4) to convert it into an RGB signal (Step S43). When the RGB signal is extracted (“Yes” in Step S42), the restoration part 36 directly proceeds to the subsequent calculation (Step S44). The restoration part 36 reads the coefficients P and Q used in the expression (4.3) calculated using the image conversion part 31 from the storage part 35 (Step S44). Also, the restoration part 36 restores the point cloud coordinates (x, y, z) by inversely transforming each of the RGB signals (Step S45).

The display part 37 can display the restored point cloud. Note that, since the restoration part 36 restores the point cloud for each outdoor structure 12, when performing displaying as one image, the display part 37 needs to combine the restored point clouds.

Note that, in the flowchart of FIG. 7, the left side of the expression (4.2) is assumed to be 2⁸-1. In the explanation of FIG. 4, when the left side of the expression (4.2) is set to 2⁸ⁱ-1 (i=1, 2, 3, . . . ) to restore the point cloud coordinates more accurately, it is explained that it is necessary to divide the generated RGB signal or YUV signal into i pieces of 8-bit each and create i pieces of image files.

In this way, when the number of convertible values of point cloud coordinates is 2⁸, at the time of restoring the point cloud coordinates from the image file, after rearranging the color signals extracted from the image file so that they are in the order when the image file is created, inverse transform is performed. For example, when the number of convertible values of point cloud coordinates is 2¹⁶, the image file includes two files composed of the upper 8 bits (R^{upper 8 bits}, G^{upper 8 bits}, B^{upper 8 bits}) and the lower 8 bits (R^{lower 8 bits}, G^{lower 8 bits}, B^{lower 8 bits}) of the generated color signal. The RGB signals extracted from this image file are rearranged in the following order: R^{upper 8 bits}, R^{lower 8 bits}, G^{upper 8 bits}, G^{lower 8 bits}, B^{upper 8 bits}, B^{lower 8 bits} so that (R^{16 bit}, G^{16 bit}, and B^{16 bit}) are provided. Also, the inverse transformation of the expression (4.3) is performed for each of the RGB signals.

Note that, in this embodiment, the explanation is based on the fact that in the future, the acquired point cloud can be used to reproduce the city in 3D on a PC. If the point cloud of objects unrelated to a communication facility such as the ground and the wall of a house is deleted, the 3D point cloud data will remain only the communication facility. With such 3D point cloud data, when the point cloud is displayed on the screen, it becomes very difficult to recognize the position of the communication facility. For this reason, the data processing device of the present invention can also hold point clouds other than a communication facility. However, depending on how the 3D point cloud data is used, it may be sufficient to store only the communication facility data. In that case, the compression ratio of the 3D point cloud data can be improved by deleting the point cloud identified as an object other than a communication facility in the description of FIG. 2.

### Embodiment 2

A data processing device 301 can also be realized by a computer and a program and the program can be recorded on a recording medium or provided over a network.

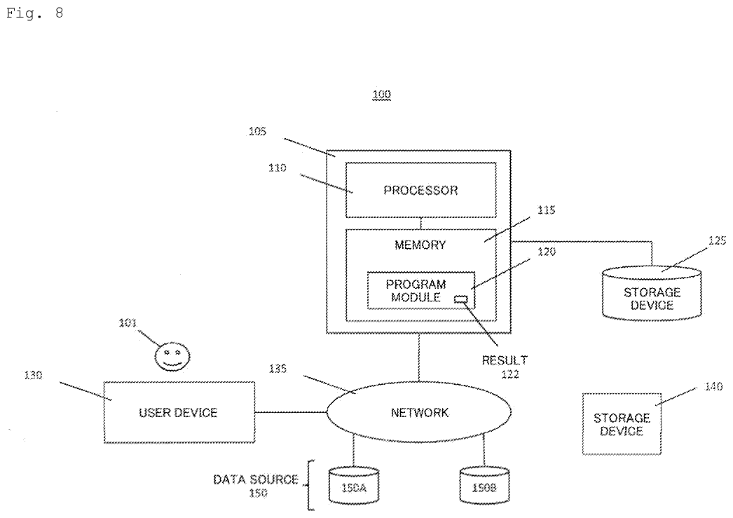

FIG. 8 illustrates a block diagram of a system 100. The system 100 includes a computer 105 connected to a network 135.

The network 135 is a data communication network. The network 135 may be a private network or a public network and can include any or all of (a) a personal area network covering, for example, a room, (b) a local area network covering, for example, a building, (c) a campus area network covering, for example, a campus, (d) a metropolitan area network covering, for example, a city, (e) a wide area network covering, for example, an area which connects across urban, rural, or national boundaries, and (f) the Internet. The communication is carried out by electronic and optical signals over the network 135.

The computer 105 includes a processor 110 and a memory 115 connected to the processor 110. Although the computer 105 is represented herein as a stand-alone device, the computer is not limited in this manner and the computer may be connected to any other device (which is not shown) in a distributed processing system.

The processor 110 is an electronic device including a logic circuit which responds to and executes instructions.

The memory 115 is a tangible computer-readable storage medium on which a computer program is encoded. In this regard, the memory 115 stores data and instructions, or program codes which can be read and executed by the processor 110 to control the operation of the processor 110. The memory 115 can be realized using a random access memory (RAM), a hard drive, or a read-only memory (ROM), or a combination thereof. One of the constituent elements of the memory 115 is a program module 120.

The program module 120 includes an instruction for controlling the processor 110 to perform the process described herein. Although operations are described in this specification as being performed by a computer 105 or a method or process or sub-process thereof, those operations are actually performed using the processor 110.

The term “module” is used in this specification to refer to a functional operation which can be embodied either as a stand-alone component or as an integrated composition of a plurality of subcomponents. Therefore, the program module 120 can be realized as a single module or as a plurality of modules which operate in cooperation with one another. Furthermore, although the program module 120 is described in this specification as being installed in the memory 115 and thus realized as software, the program module can be realized in hardware (for example, electronic circuitry), firmware, software, or a combination thereof.

The program module 120 is illustrated as already being loaded in the memory 115 but may be configured to be located on the storage device 140 for later loading into the memory 115. The storage device 140 is a tangible computer-readable storage medium which stores the program module 120. Examples of the storage device 140 include a compact disc, a magnetic tape, a read-only memory, an optical storage media, a memory unit including a hard drive or a plurality of parallel hard drives, and a universal serial bus (USB) flash drive. Alternatively, the storage device 140 may be a random access memory or any other kind of electronic storage device located in a remote storage system (not shown) and connected to the computer 105 over the network 135.

The system 100 further includes a data source 150A and a data source 150B collectively referred to in this specification as data sources 150 and communicatively connected to the network 135. In practice, the data source 150 can include any number of data sources, that is, one or more data sources. The data source 150 can include non-systemized data and can include social media.

The system 100 further includes a user device 130 which is operated by a user 101 and connected to the computer 105 over the network 135. The user device 130 includes input devices such as a keyboard or a voice recognition sub-system for allowing the user 101 to communicate information and command selections to the processor 110. The user device 130 further includes an output device such as a display device or a printer or a speech synthesizer. A cursor control unit such as a mouse, a trackball, and a touch-sensitive screen allows the user 101 to manipulate the cursor on the display device to communicate further information and command selection to the processor 110.

The processor 110 outputs the results 122 of the execution of the program module 120 to the user device 130. Alternatively, the processor 110 may provide an output to the storage 125 such as a database or memory or to a remote device (not shown) over the network 135.

For example, the program module 120 may be a program which performs the flowcharts of FIGS. 4 to 7. The system 100 can be operated as an image conversion part 31, an image compression part 34, and a restoration part 36, respectively.

Although the terms “comprising . . . ” or “including . . . ” explicitly describe the presence of the features, integers, steps, or constituent elements referred to therein, the terms are not to be interpreted as excluding the presence of one or more other features, integers, steps or constituent elements, or groups thereof. The terms “a” and “an” are indefinite articles and thus do not exclude embodiments having a plurality thereof.

### OTHER EMBODIMENTS

Note that the present invention is not limited to the above-described embodiments and various modifications can be made without departing from the gist of the present invention. In short, the present invention is not limited to the high-level embodiments as they are, and can be embodied by modifying the constituent elements without departing from the scope of the present invention at the implementation stage.

Moreover, various inventions can be formed by appropriately combining a plurality of constituent elements disclosed in the above embodiments. For example, some constituent elements may be omitted from all components shown in the embodiments. Furthermore, constituent elements across different embodiments may be combined as appropriate.

### Effects of Invention

It is believed that the point cloud data compression program according to the present disclosure has some advantages over the related art.

Since the entire 3D point cloud data is converted into an image file at once and the image compression technique which is irreversible compression is used for the image file in the related art, color signals are converted into different signals during compression which affects the coordinate accuracy during restoration. On the other hand, the data processing device of the present invention can adjust the coordinate accuracy during restoration by identifying a facility from the 3D point cloud data and changing the compression ratio for each facility. For this reason, it is possible to maintain 3D model creation accuracy while compressing 3D point cloud data and it is possible to apply a facility inspection technique using 3D laser scanners even after 3D point cloud data compression.

### REFERENCE SIGNS LIST

11 3D laser scanner
12 Facility (outdoor structures)
21 Identification surface
22 Area of Class 1
23 Area of Class 2
24 Identification object 1 included in Class 1
25 Identification object 2 included in Class 2
30 Object-to-be-measured identification processing part
31 Image conversion part
32 Coordinate identification part
33 Image creation part
34 Image compression part
35 Storage part
36 Restoration part
37 Display part
100 System
101 User
105 Computer
110 Processor
115 Memory
120 Program module
122 Result
125 Storage device
130 User device
135 Network
140 Storage device
150 Data source
301 Data processing device

1. A data processing device which processes three-dimensional (3D) point cloud data representing three-dimensional coordinates of points on a surface of an outdoor structure acquired using a three-dimensional laser scanner, comprising:
an image conversion part configured to generate an image file in which three-dimensional coordinates of each of the points of the three-dimensional point cloud data are regarded as color signals for each of the outdoor structures;
an image compression part which performs image compression processing on each of the image files at a compression ratio determined for each type of the outdoor structure corresponding to the image file; and
a storage part which stores a compressed image file subjected to the image compression processing and parameters used in the image compression processing in association with each other.

2. The data processing device according to claim 1, further comprising:
a restoration part which converts the compressed image file into three-dimensional coordinate points using the compressed image file and the parameters stored in the storage part to generate restored point cloud data for each of the outdoor structures.

3. The data processing device according to claim 1, wherein the image conversion part converts a numerical value of the color signal corresponding to the three-dimensional coordinates of one point into a binary number and creates a plurality of image files for each 8 bits from the upper binary number.

4. The data processing device according to claim 1, wherein the image conversion part calculates a divisor of the number of point clouds included in the three-dimensional point cloud data for each of the outdoor structures,
sets the number of point clouds to x when the number of point clouds is 8 or more and is not a prime number, assigns dummy data to the three-dimensional point cloud data for each of the outdoor structures and sets a sum of the number of the point clouds and the number of the dummy data to x or deletes some points from the 3D point cloud data for each of the outdoor structures and subtracts the number of deleted points from the number of the point cloud to obtain x so that it has a divisor other than 1 and the number of the point clouds when the number of the point clouds is less than 8 or a prime number, and
creates the image file of pixels which are expressed by two divisors of the x.

5. The data processing device according to claim 2, wherein the image compression part
collectively performs moving image compression processing on a plurality of the image files generated from the outdoor structure which are of the same type and which are present in different locations to obtain the compressed image files.

6. The data processing device according to claim 5, wherein the restoration part extracts an arbitrary image file from the compressed image file which is a compressed moving image, converts it into points of three-dimensional coordinates, and generates restored point cloud data for each of the outdoor structures.

7. A data processing method for processing three-dimensional point cloud data representing three-dimensional coordinates of points on a surface of an outdoor structure acquired using a three-dimensional laser scanner, comprising:
generating an image file in which three-dimensional coordinates of each point of three-dimensional point cloud data are regarded as color signals for each of outdoor structures;
performing image compression processing on each of the image files at a compression ratio determined for each type of the outdoor structure corresponding to the image file; and
storing the compressed image file subjected to the image compression processing and the parameters used for the image compression processing in association with each other.

8. A non-transitory computer-readable medium having computer-executable instructions that, upon execution of the instructions by a processor of a computer, cause the computer to function as the data processing device according to claim 1.
